(19) United States
(12) Patent Application Publication
(10) Pub. No.: US 2025/0212716 A1
(43) Pub. Date: Jul. 3, 2025

(54) MULTI SECTION FOLDING IMPLEMENT WITH FLEX COUPLING SYSTEMS ON OUTER WING MEMBERS

(71) Applicant: Farmada, LLC, Salina, KS (US)

(72) Inventors: Tanner Shaffer, Kanopolis, KS (US); Daniel Rauchholz, Lindsborg, KS (US)

(21) Appl. No.: 19/005,878

(22) Filed: Dec. 30, 2024

Related U.S. Application Data
(60) Provisional application No. 63/616,467, filed on Dec. 29, 2023.

(51) Int. Cl. A01B 73/04; A01B 73/06

(52) U.S. Cl. CPC A01B 73/046; A01B 73/065

(57) ABSTRACT

A farm implement has a frame assembly with a carrier frame and a pair of wing frame assemblies each having a plurality of wing members. First wing members are pivotally coupled to the carrier frame for rotation about first horizontal axes, second wing members are pivotally coupled to the first wing members for rotation about second horizontal axes, and third wing members are pivotally coupled to the second wing members for rotation about vertical axes. Hydraulic actuator assemblies are provided for folding and unfolding the wing frame assemblies. Flex coupling systems are provided to allow the third wing members to float about horizontal axes relative to the second wing members when the third wing members are in their extended working positions. Hydraulic actuators with slotted connections allow a limited range of floating movement of the third wing members and keep the third wing members level when the implement is raised.

### RELATED APPLICATIONS

This application claims the benefit of U.S. Provisional Patent Application No. 63/616,467 filed on Dec. 29, 2023, the contents of which are incorporated herein by reference.

### BACKGROUND OF THE INVENTION

### Field of the Invention

The present invention relates generally to farm implements, and in particular, to farm implements having multiple sections of folding wing members that allow the implement to be folded between a folded transport position and an extended working position.

### Description of the Related Art

The field of folding farm implements has seen significant advancements aimed at improving operational efficiency and adaptability to diverse terrain conditions. U.S. Pat. No. 8,820,429, issued to CNH Industrial America LLC, discloses a folding implement frame with an outer wing section fixed against floating movement in its extended position. While the '429 patent demonstrates the utility of multi-section frames for folding and transport, it does not address the need for outer wing sections to float about a longitudinal horizontal axis in their extended working position to adapt to uneven terrain.

Related art also includes implements with drawbars and wing sections that can be folded forwardly about a vertical axis and allowed to flex about a longitudinal horizontal axis. However, these designs are limited to simpler frame configurations and lack integration with multi-section frames like those disclosed in the '429 patent. To date, no related art has combined the flexibility of floating wing sections with the complexity of multi-section folding frames, which are essential for larger-scale agricultural operations.

### SUMMARY OF THE INVENTION

The present invention provides an improved multi-section folding farm implement that addresses the limitations of the prior art by incorporating flex coupling systems on the outer wing sections. These systems enable the outer wing sections to float about a longitudinal horizontal axis when in their extended working position, allowing the implement to adapt to uneven terrain.

The farm implement comprises a frame assembly with a carrier frame and wing frame assemblies, each having first, second, and third wing members. Hydraulic actuator assemblies facilitate folding and unfolding the wing members about horizontal and vertical axes. The third wing members include flex coupling systems with hydraulic actuators and slotted connections that enable controlled floating movement, thereby enhancing terrain adaptability without compromising structural stability.

This innovative design integrates the benefits of floating wing sections and multi-section frames, offering superior flexibility and operational efficiency for agricultural applications.

A farm implement according to one aspect of the present invention comprises: a frame assembly including a carrier frame and a pair of wing frame assemblies mounted to the carrier frame, each wing frame assembly including first, second, and third wing members with the first wing members pivotally coupled to the carrier frame for rotation about first horizontal axes, the second wing members pivotally coupled to the first wing members for rotation about second horizontal axes, and the third wing members pivotally coupled to the second wing members for rotation about vertical axes. The implement also includes first and second hydraulic actuator assemblies, wherein the first hydraulic actuator assembly is interconnected between the carrier frame and the first wing members of the wing frame assemblies for folding and unfolding the first wing members relative to the carrier frame about the first horizontal axes, and wherein the second hydraulic actuator assembly is interconnected between the first wing members and the second wing members of the wing frame assemblies for folding and unfolding the second wing members relative to the first wing members about the second horizontal axes. A third hydraulic actuator assembly is interconnected between the second wing members and the third wing members of the wing frame assemblies for folding and unfolding the third wing members relative to the second wing members about the vertical axes, the third wing members being configured to pivot forward about the vertical axes from an extended working position to a folded transport position. The third wing members comprise flex coupling systems that allow the third wing members to float about third horizontal axes relative to the second wing members when the third wing members are in their extended working positions.

A farm implement according to another aspect of the present invention comprises: a frame assembly including a carrier frame and a pair of wing frame assemblies mounted to the carrier frame, each wing frame assembly including first, second and third wing members, wherein the first wing members are pivotally coupled to the carrier frame for rotation about first horizontal axes, the second wing members are pivotally coupled to the first wing members for rotation about second horizontal axes, and the third wing members are pivotally coupled to the second wing members for rotation about vertical axes. Hydraulic actuator assemblies are configured to fold and unfold the wing members about the respective horizontal and vertical axes. Flex coupling systems on the third wing members comprise main frames pivotally connected to the second wing members for rotation about the vertical axes, wing frames pivotally connected to the main frames for rotation about longitudinal horizontal axes, and a connection system allowing limited floating movement of the wing frames relative to the main frames. The connection system includes slotted guide supports with slots, and lug pins that slide within the slots. Ground support wheels are provided on the carrier frame, the first wing members, and the second wing members, and a hydraulic system is provided for moving the ground support wheels relative to the carrier frame and first and second wing members for moving the carrier frame and the first and second wing members between a lowered field working position and a raised transport position. Adjustable gauge wheels are provided on the third wing members for controlling a depth of operation of the third wing members in their extended working positions. The flex coupling systems enable the third wing members to float about the longitudinal horizontal axes in response to uneven terrain while maintaining alignment with the second wing members.

Numerous other objects of the present invention will be apparent to those skilled in this art from the following description wherein there is shown and described embodiments of the present invention, simply by way of illustration of some of the modes best suited to carry out the invention. As will be realized, the invention is capable of other different embodiments, and its several details are capable of modification in various obvious aspects without departing from the invention. Accordingly, the drawings and description should be regarded as illustrative in nature and not restrictive.

### BRIEF DESCRIPTION OF THE DRAWINGS

The present invention will become more clearly appreciated as the disclosure of the present invention is made with reference to the accompanying drawings.

In the drawings:

FIG. 1 is a perspective view of a multi section folding implement according to the present invention.

FIG. 2 is a front elevation view of the multi section folding implement shown in FIG. 1, with the wing frame assemblies shown in various positions of flexing to follow uneven terrain.

FIG. 3 is a detail perspective view of a flex coupling system used on an outer wing member of the multi section folding implement, with the outer wing member in its extended working position and flexed downwardly.

FIG. 4 is another detail perspective view of the flex coupling system shown in FIG. 3.

FIG. 5 is a detail perspective view of a gravity lock used to lock the outer wing member to the adjacent wing member when the implement is folded into its transport position.

FIG. 6 is a detail perspective view showing the outer wing member in a partially folded position between its extended working position and its folded transport position.

FIG. 7 is a detail perspective view showing the outer wing member in its folded transport position.

FIG. 8 is a detail perspective view showing the flex coupling system with the outer wing member in its extended working position.

FIG. 9 is an exploded view showing the components of the flex coupling system shown in FIG. 8.

FIGS. 10 to 14 are plan, perspective, front elevation, side elevation, and rear elevation views, respectively, of the outer wing member in its extended working position and flexed upwardly.

FIGS. 15 to 20 are additional perspective and detail views showing the flex coupling system used to attach the outer wing member to the implement, with the outer wing member in its extended working position and flexed upwardly.

FIGS. 21 to 25 are plan, perspective, front elevation, side elevation, and rear elevation views, respectively, of the outer wing member in its extended working position and flexed downwardly.

FIGS. 26 to 31 are additional perspective and detail views showing the flex coupling system used to attach the outer wing member to the implement, with the outer wing member in its extended working position and flexed downwardly.

FIG. 32 is a plan view of the outer wing member in an intermediate position between its extended working position and its folded transport position.

FIGS. 33, 34 and 36 are perspective views of the outer wing member in its intermediate position shown in FIG. 32, and FIG. 35 is a detail view of the flex coupling shown in FIG. 34.

FIGS. 37 and 38 are front elevation and side elevation views of the outer wing member in its intermediate position shown in FIG. 32.

FIGS. 39, 40, 42, 43, 45 and 46 are plan, left side perspective, right side perspective, right side perspective, front elevation, and side elevation views of the implement showing the outer wing member in its folded transport position.

FIG. 41 is a detail view of the gravity lock in its locked position with the outer wing member in its folded transport position.

FIG. 44 is a detail view of the flex coupling shown in FIG. 43 with the outer wing member in its folded transport position.

FIGS. 47 to 49 are perspective, plan, and front elevation views, respectively, of the multi section folding implement with the outer wing members in their extended working positions and flexed downwardly.

FIGS. 50 to 52 are perspective, plan, and front elevation views, respectively, of the multi section folding implement with the outer wing members in their extended working positions and flexed upwardly.

FIGS. 53 to 55 are perspective, plan, and front elevation views, respectively, of the multi section folding implement with the outer wing members in their extended working positions, and with one outer wing member flexed upwardly and one outer wing member flexed downwardly.

FIGS. 56 to 58 are perspective, plan, and front elevation views, respectively, of the multi section folding implement with all of the wing members flexed downwardly.

FIGS. 59 and 60 are perspective and front elevation views, respectively, of the multi section folding implement with all wing members on one side flexed downwardly, and all wing members on the other side flexed upwardly.

FIGS. 61 and 62 are perspective and front elevation views, respectively, of the multi section folding implement with the wing members flexed in various directions to follow uneven terrain.

FIGS. 63 is a perspective view of the multi section folding implement with the wind members flexed in various directions to follow uneven terrain.

FIGS. 64 and 65 are plan views and front elevation views, respectively, of the multi section folding implement shown in FIG. 1 in its extended working position.

FIGS. 66 to 70 are perspective, detail, perspective, plan and front elevation views, respectively, of the multi section folding implement with the outer wing members in intermediate positions between their extended working positions and their folded transport positions.

FIGS. 71 to 75 are perspective, detail, perspective, plan, and front elevation views, respectively, of the multi section folding implement with the outer wing members in their folded transport positions.

FIGS. 76 to 78 are perspective, plan, and front elevation views, respectively, of the multi section folding implement with the outer wing members being in their locked transport positions and the second wing members partially folded.

FIGS. 79 to 82 are perspective, perspective, plan, and front elevation views, respectively, of the multi section folding implement with the second wing members folded inwardly 90 degrees.

FIGS. 83 to 85 are perspective, plan, and front elevation views, respectively, of the multi section folding implement with the second wing members folded inwardly approximately 135 degrees.

FIGS. 86 to 88 are perspective, plan, and front elevation views, respectively, of the multi section folding implement with the second wing members folded inwardly approximately 175 degrees.

FIGS. 89 and 90 are perspective views of the multi section folding implement with the first wing members partially folded inwardly.

FIG. 91 is a detail view of the gravity lock in a locked position for holding the outer wing member fixed relative to the second wing member.

FIGS. 92 and 93 are plan and front elevation views of the multi section folding implement with the first wing members partially folded inwardly.

FIGS. 94, 95, 97 and 98 are perspective, perspective, plan, and front elevation views of the multi section folding implement with the first wing members completely folded inwardly to their folded transport positions.

FIG. 96 is a detail view of the gravity lock in a locked position for holding the outer wing member fixed relative to the second wing member in the folded transport position.

### DETAILED DESCRIPTION OF THE INVENTION

A multi section folding farm implement 10 with flex coupling systems on the outer wing members according to the present invention will be described with reference to the accompanying drawings.

The farm implement 10 includes a frame assembly 11 with a carrier frame 12 and a pair of wing frame assemblies 13, 14 each having a plurality of wing members 15, 16, 17. The pair of wing frame assemblies 13, 14 are arranged on the right and left sides of the carrier frame 12, respectively. The carrier frame 12 has a plurality of ground support wheels 18 and a tongue 19 for towing the implement 10 behind a vehicle, such as an agricultural tractor. Ground support wheels 20 are also provided on the wing frame assemblies 13, 14 for supporting the implement 10 when the wing frame assemblies 13, 14 are unfolded. A rear hitch 21 is provided on the carrier frame 12 for towing a fertilizer tank, bulk commodities trailer or the like behind the implement 10.

The wing frame assemblies 13, 14 in the illustrated embodiment each have first, second and third wing members 15-17 that can be folded between a narrow transport position and an extended working position. The first wing members 15 are pivotally coupled to the carrier frame 12 for rotation about first horizontal axes 22. The second wing members 16 are pivotally coupled to the first wing members 15 for rotation about second horizontal axes 23. First and second hydraulic actuator assemblies 24, 25 are provided to pivot the first and second wing members 15, 16 about the first and second horizontal axes 22, 23, respectively. A single hydraulic circuit with interconnected hydraulic lines between the first and second hydraulic actuator assemblies 24, 25 can be used to fold and unfold the first and second wing members 15, 16.

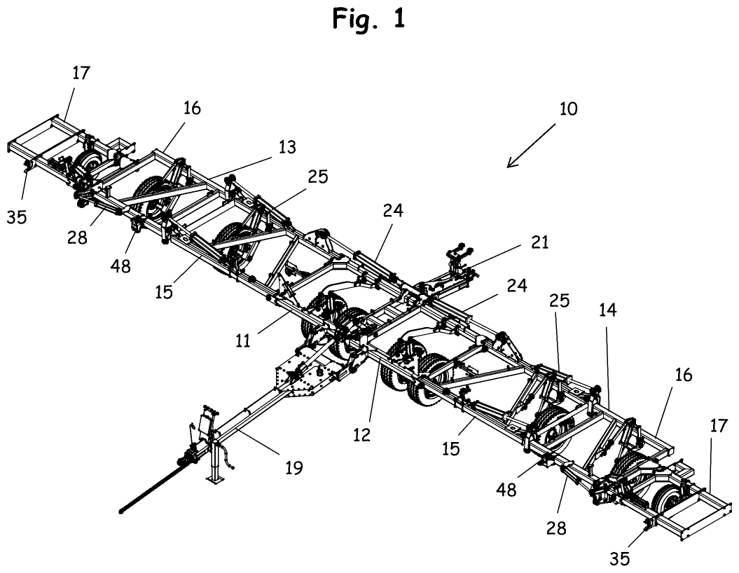

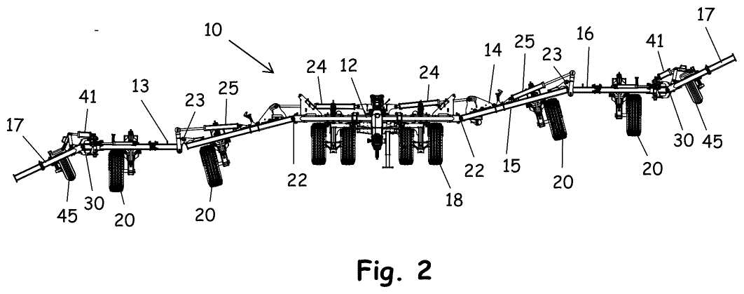

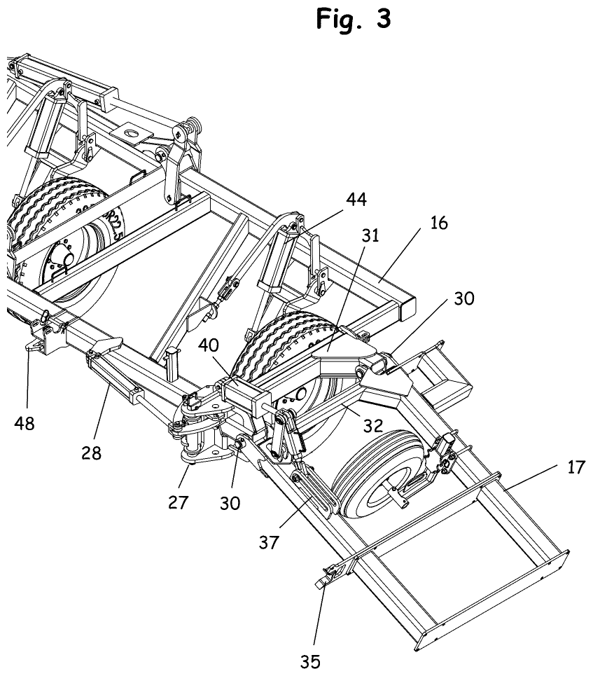

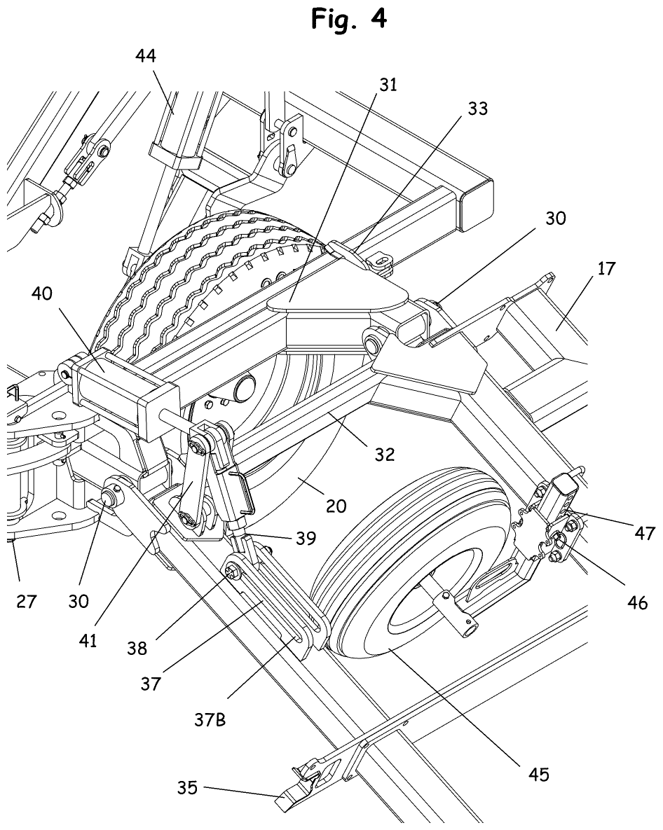

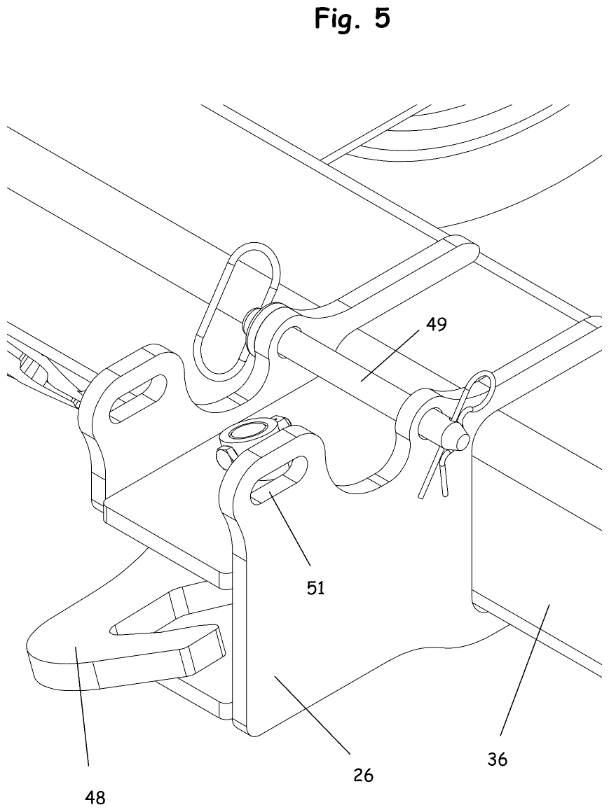

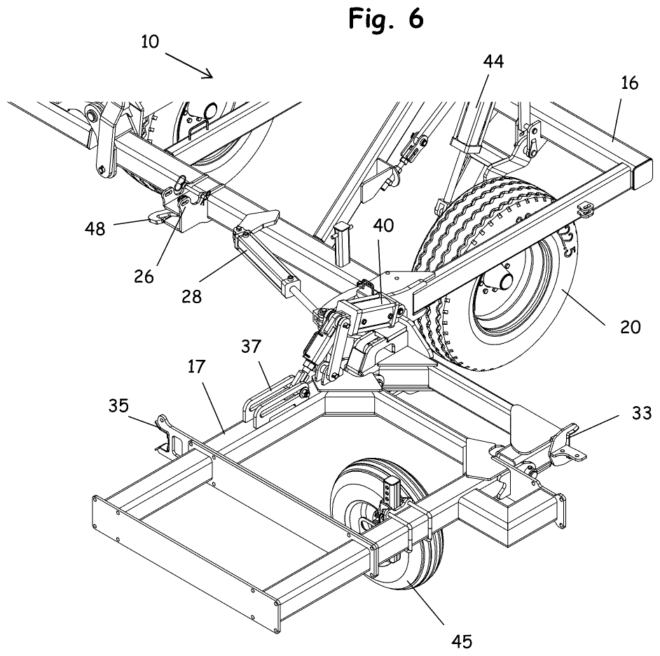

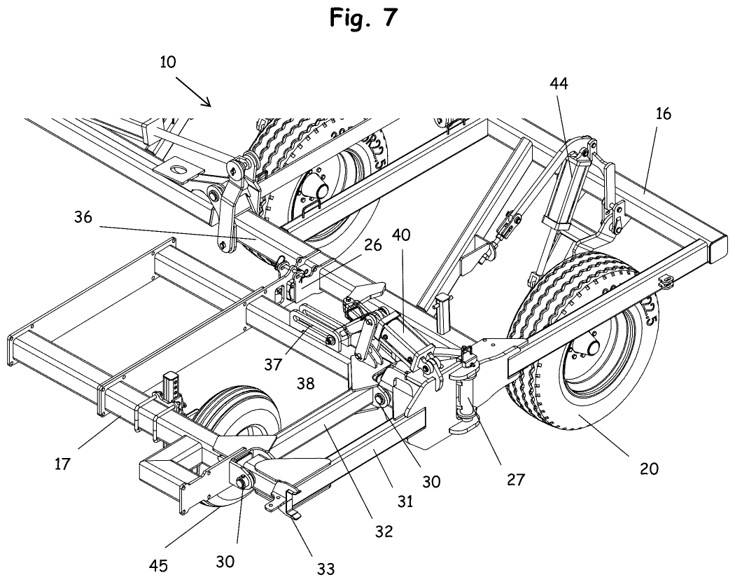

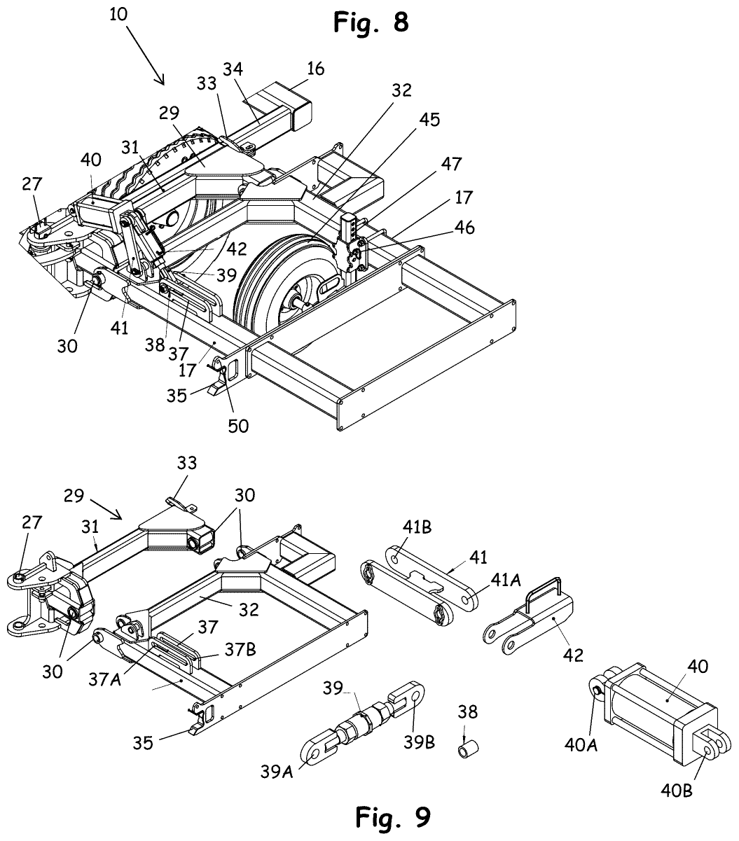

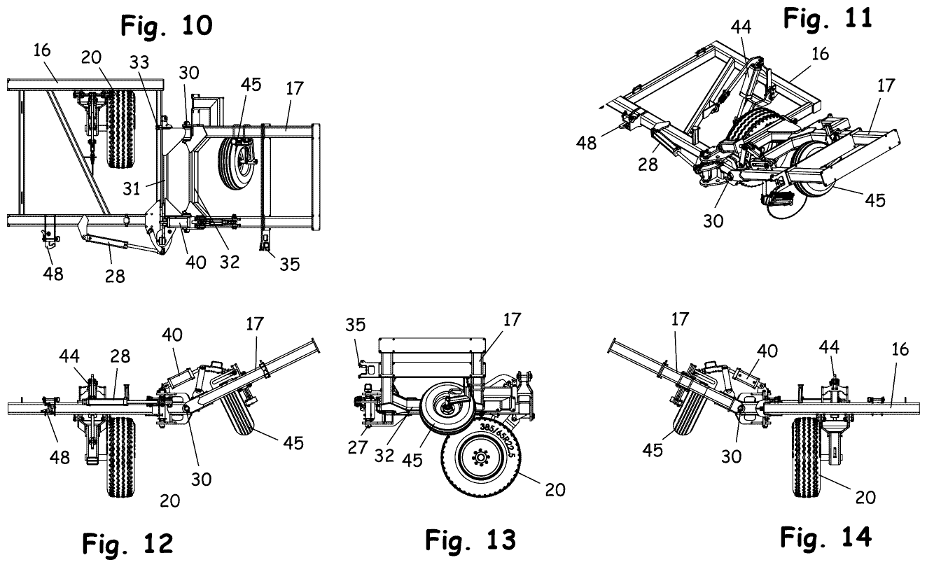

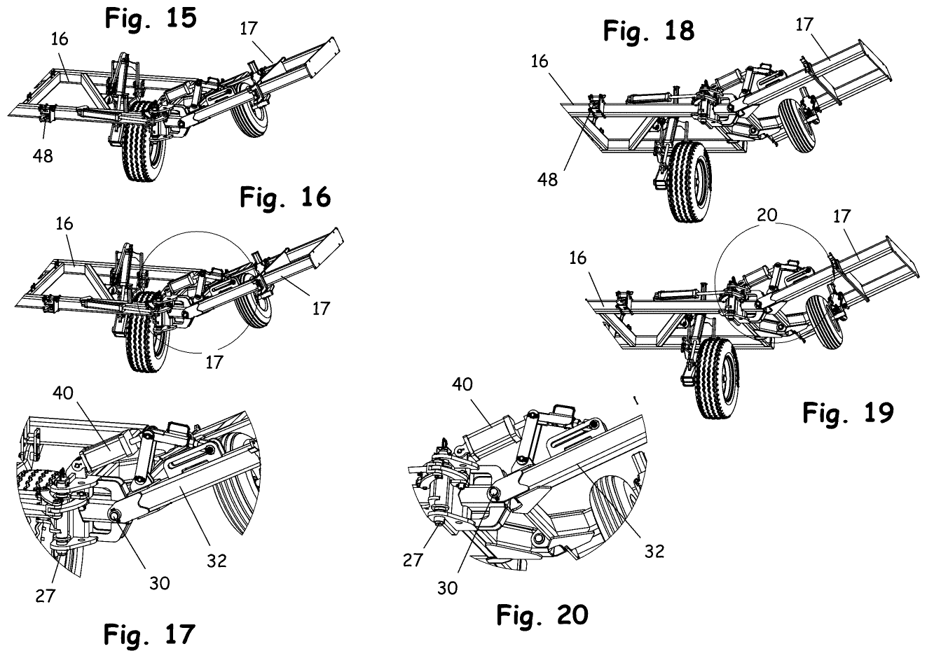

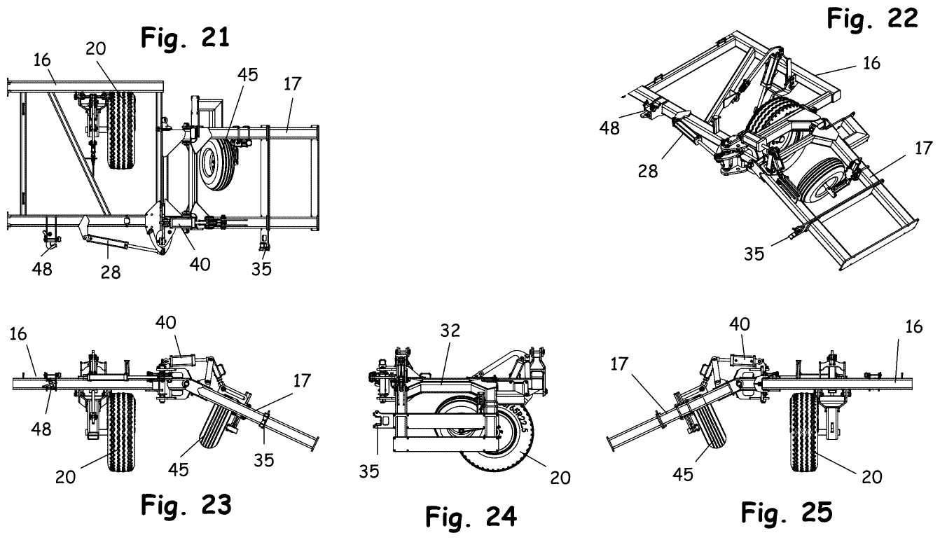

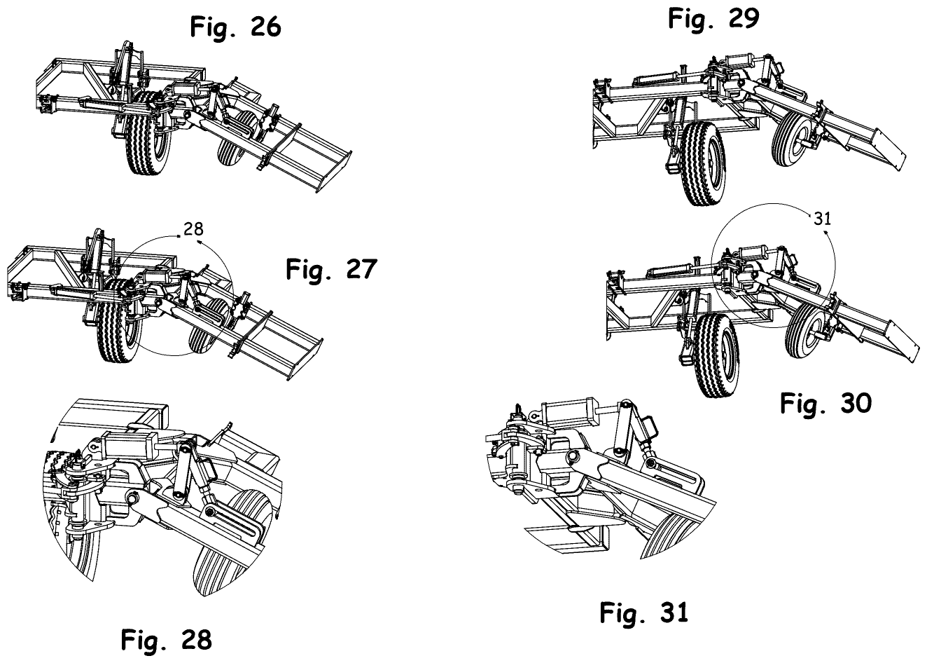

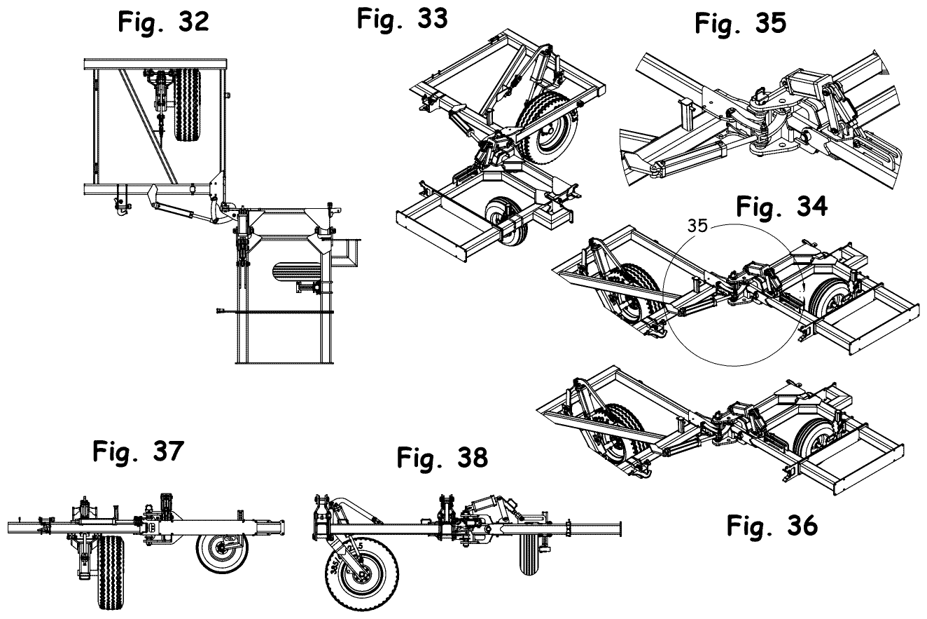

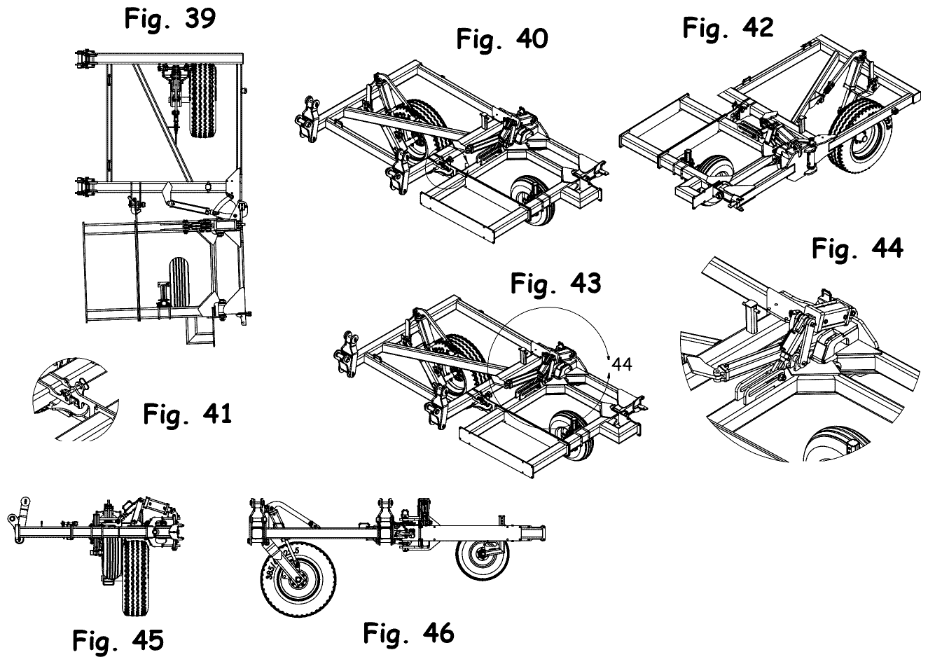

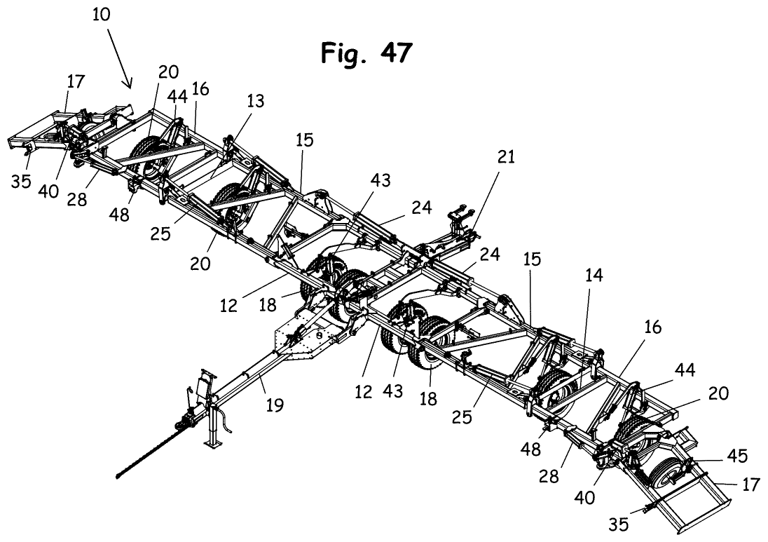

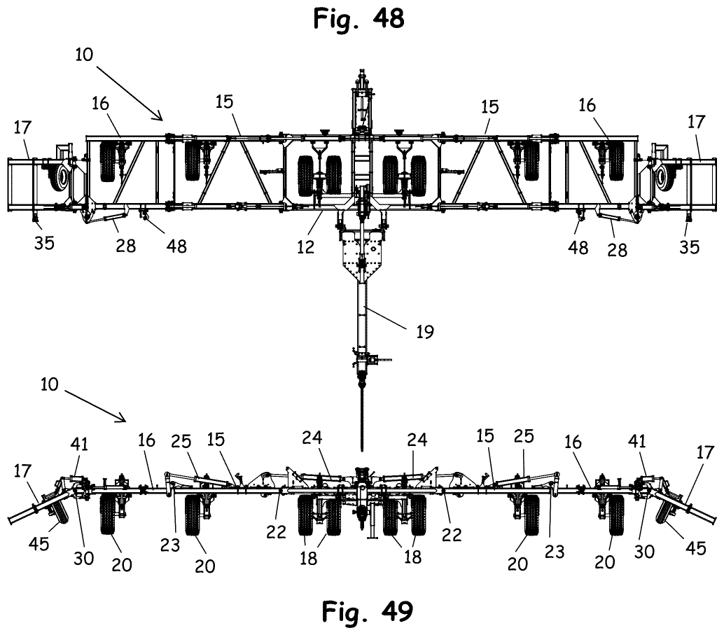

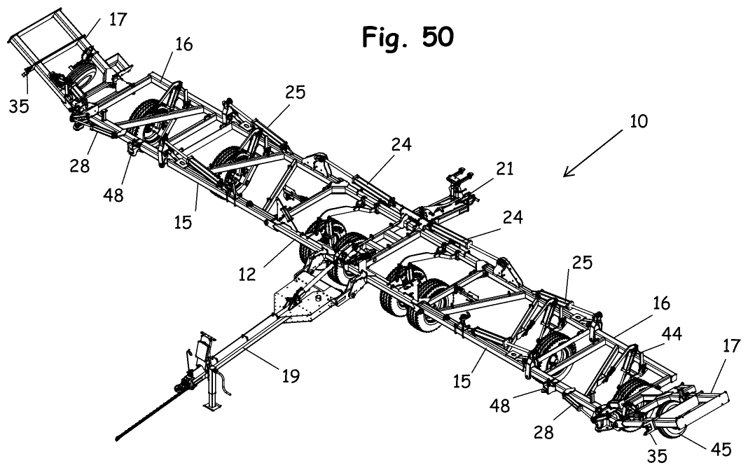

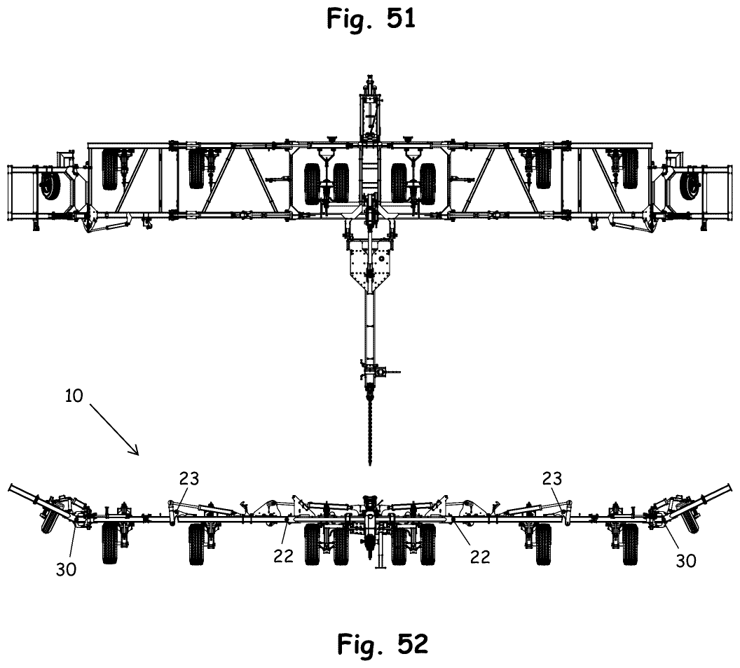

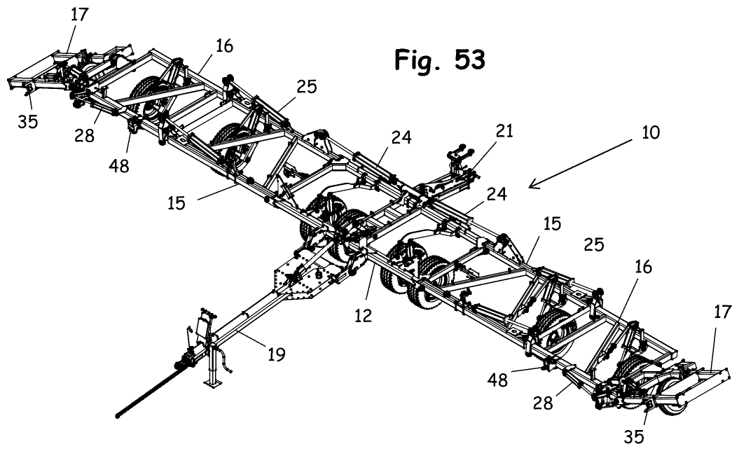

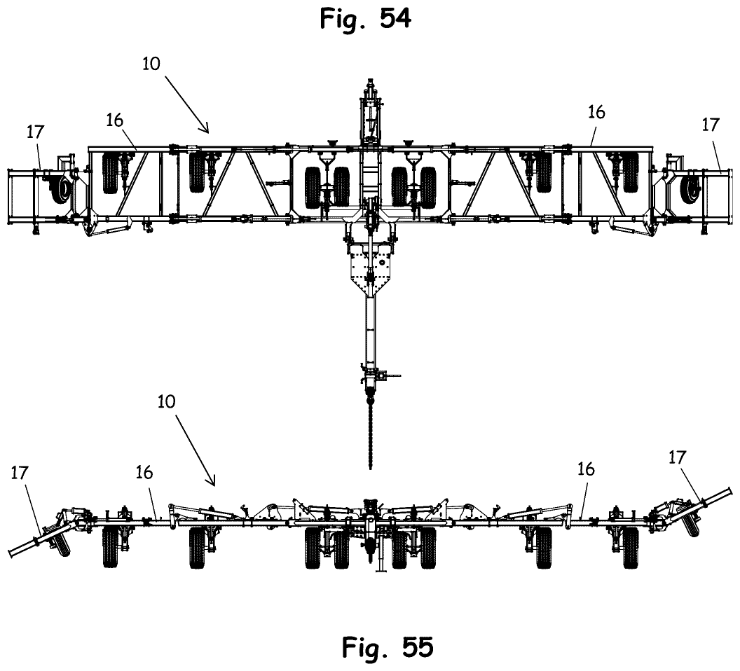

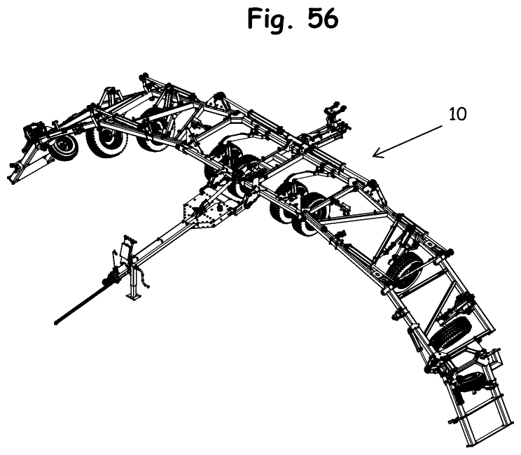

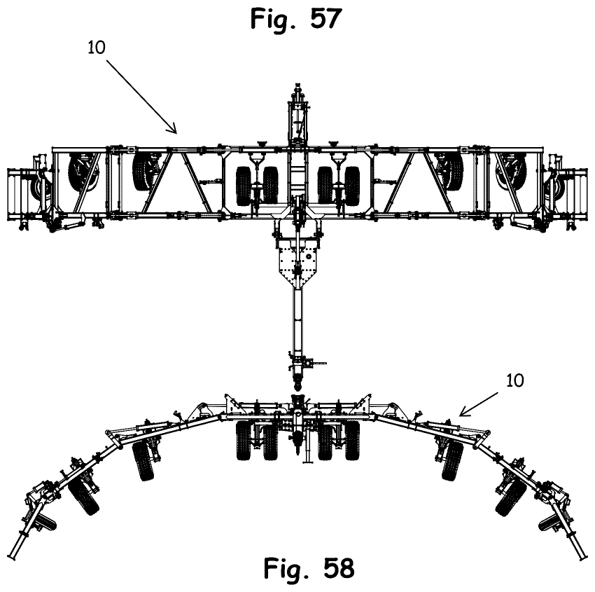

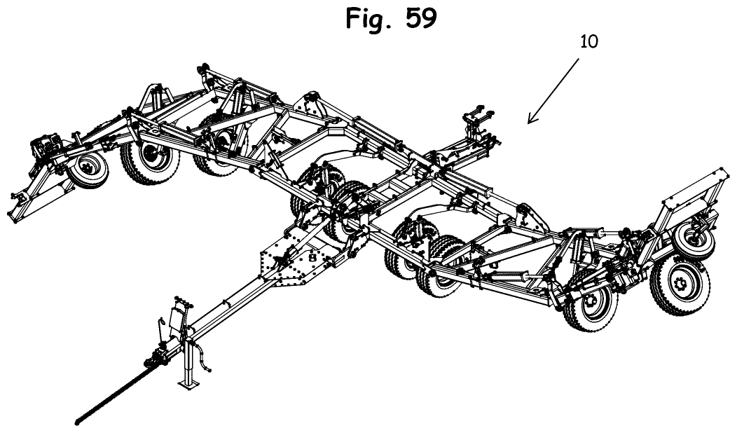

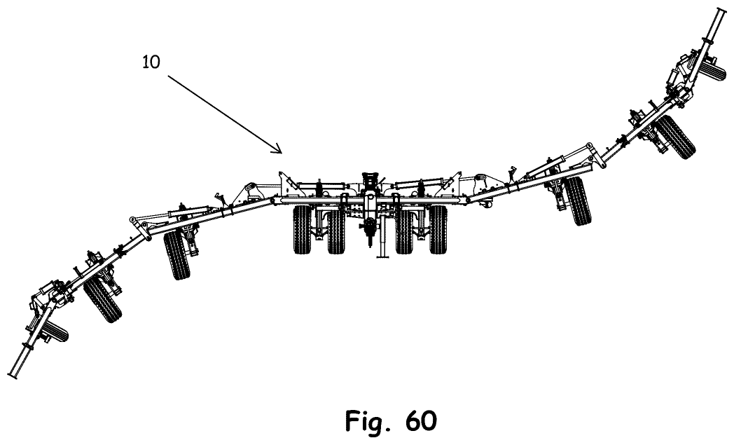

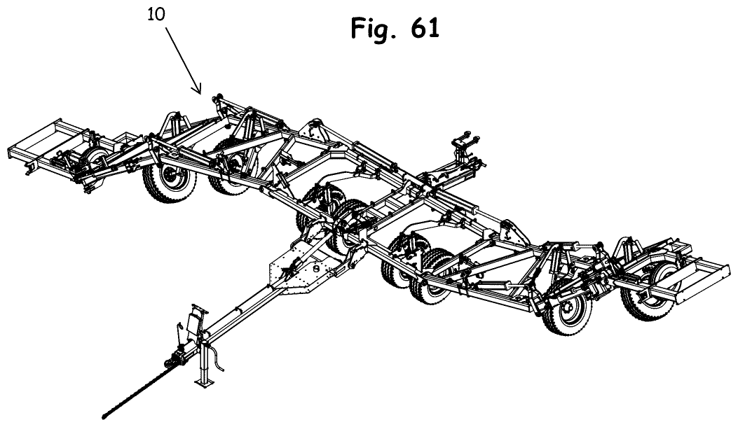

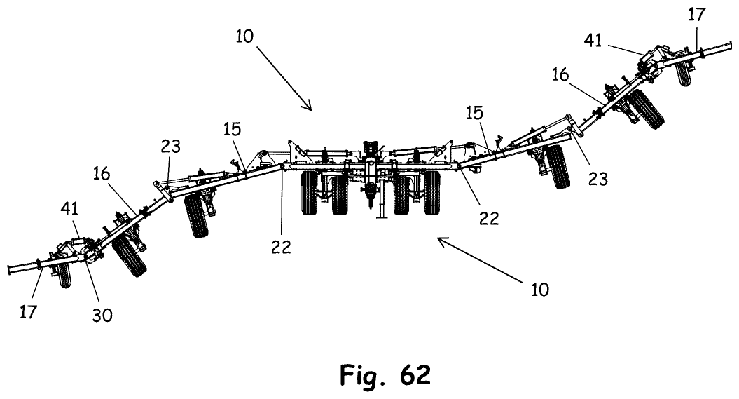

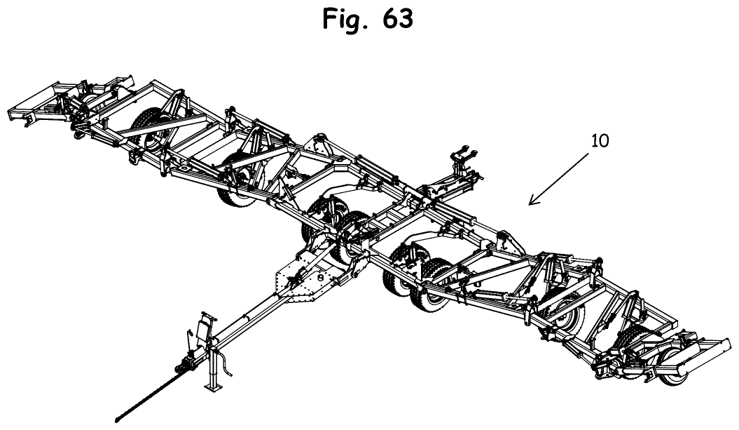

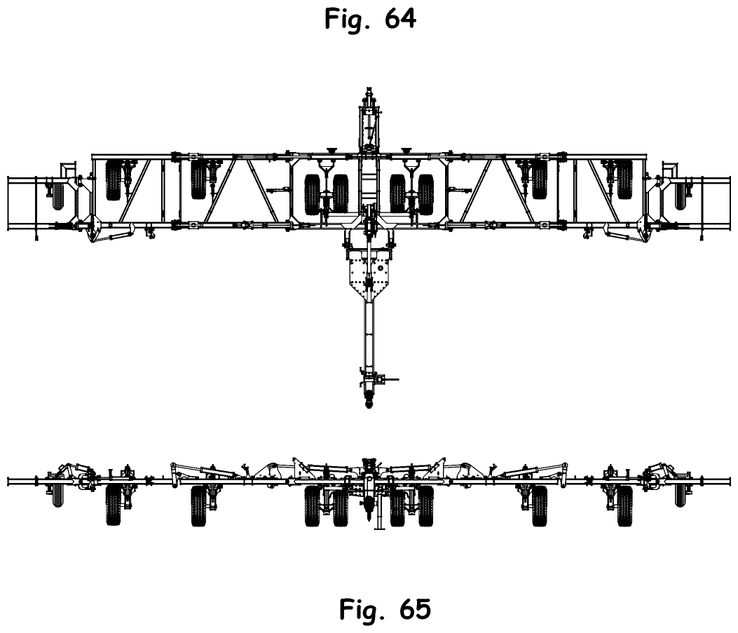

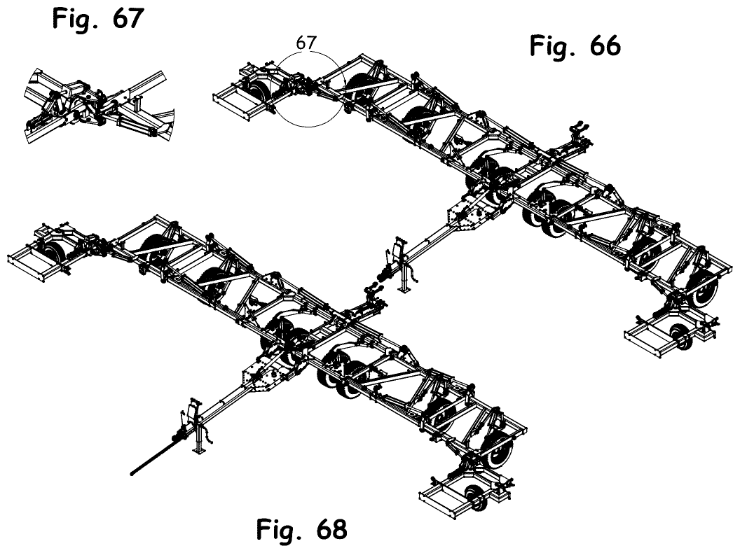

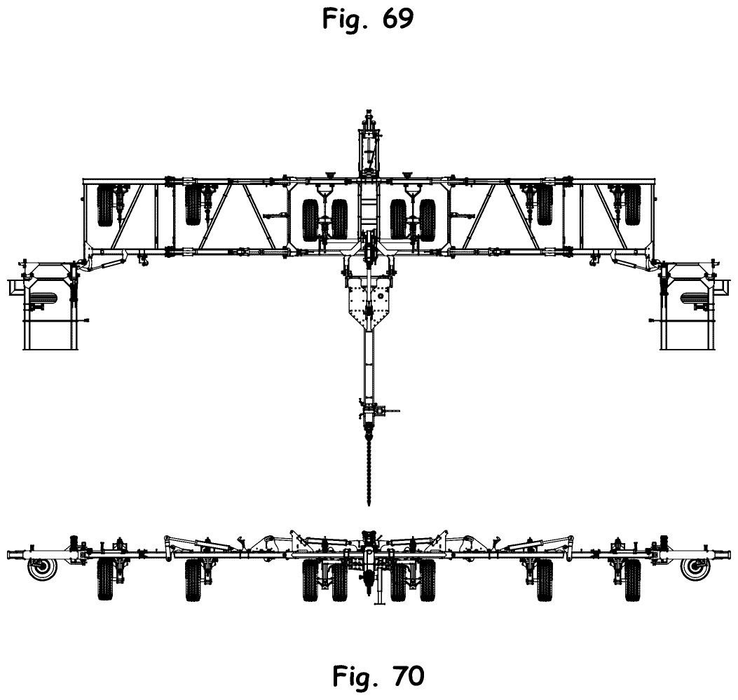

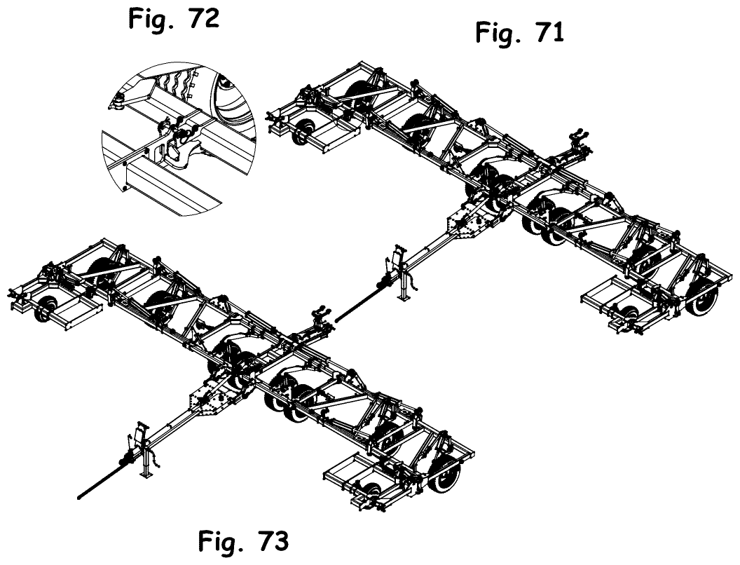

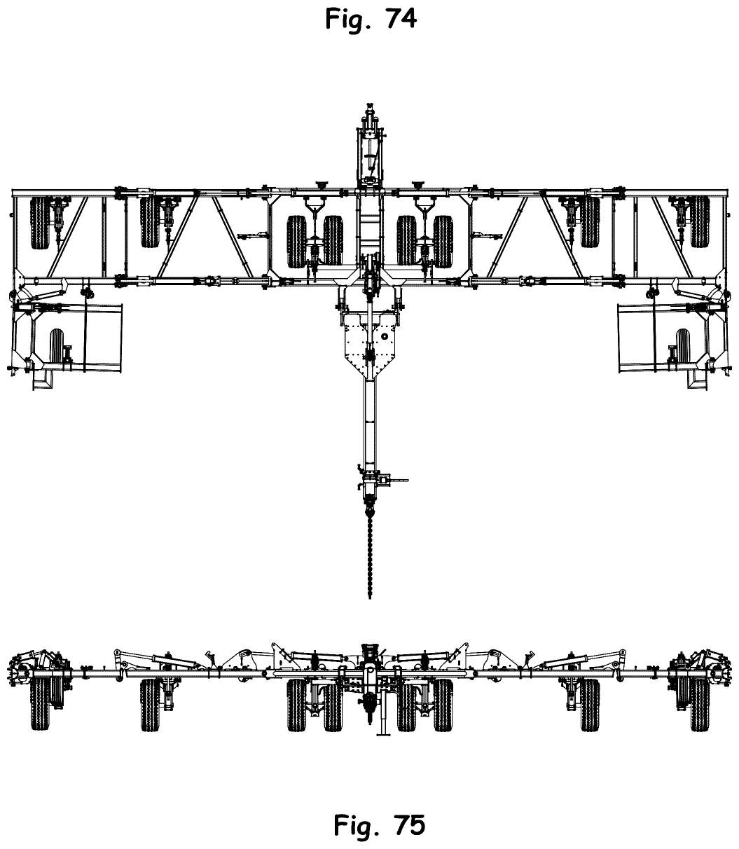

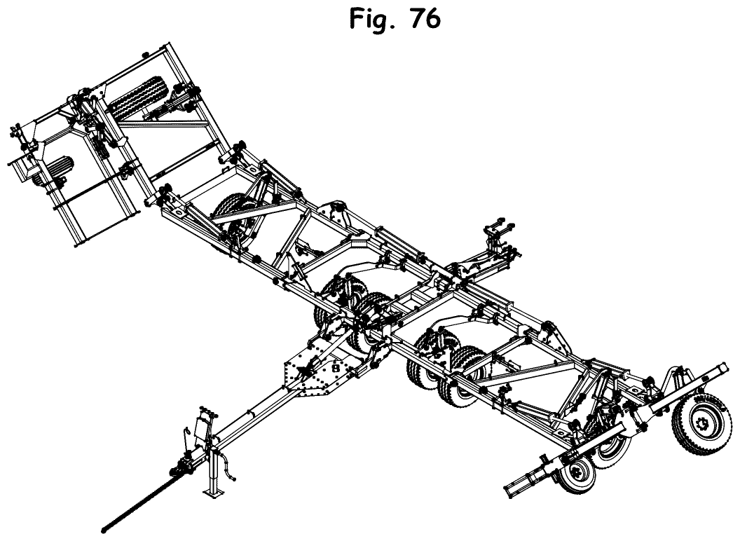

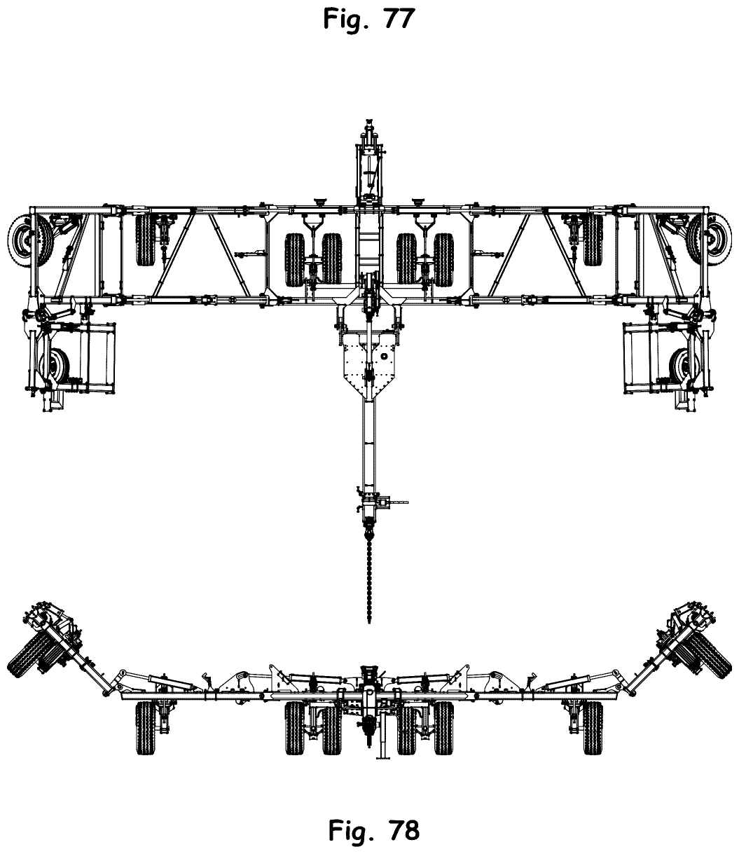

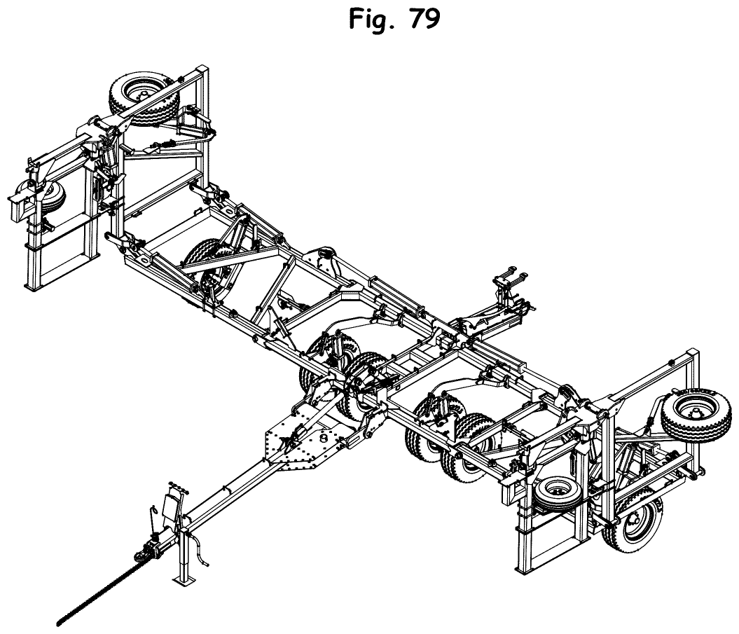

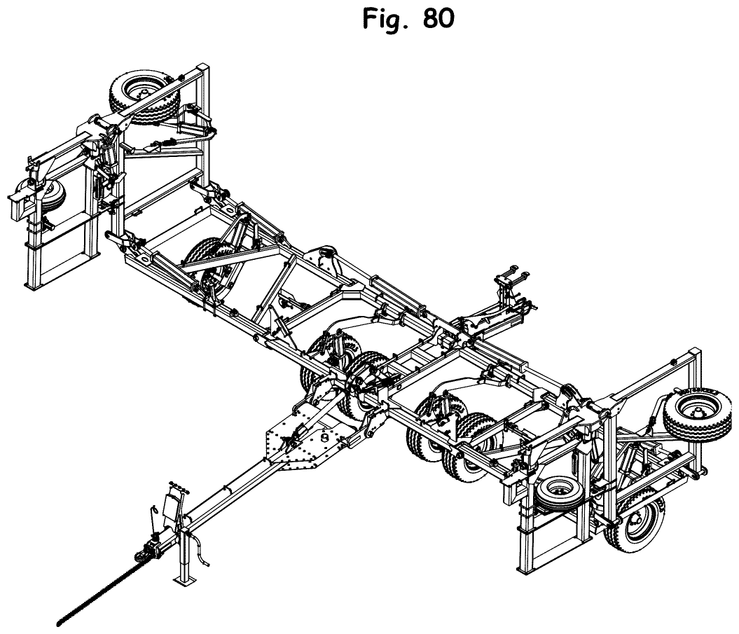

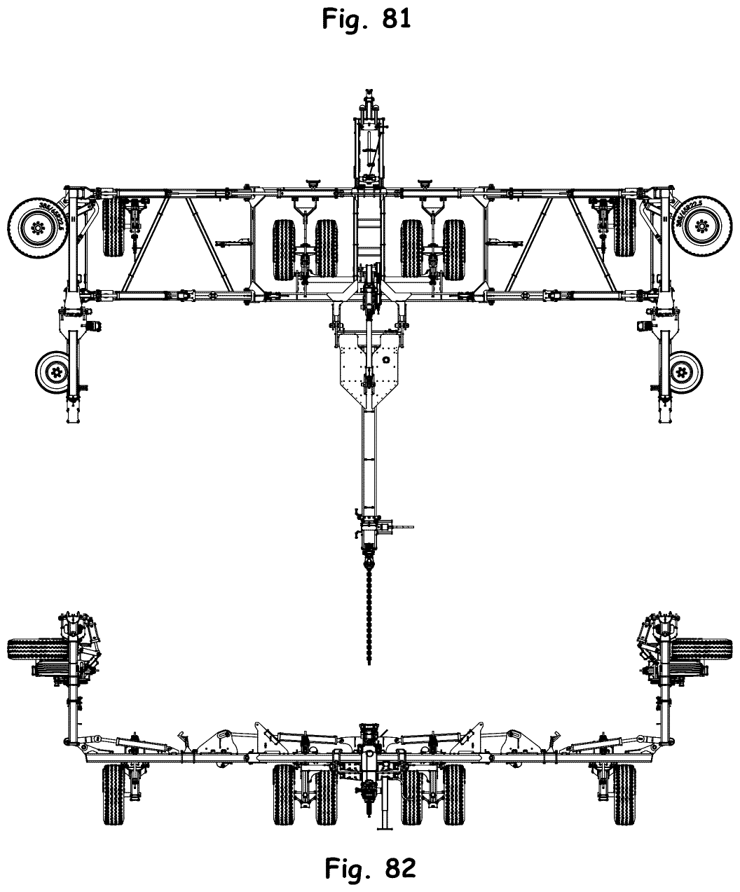

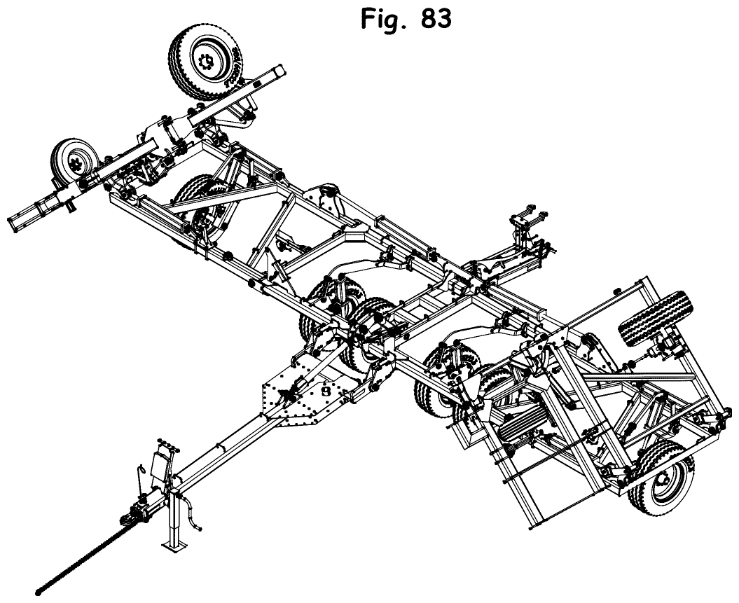

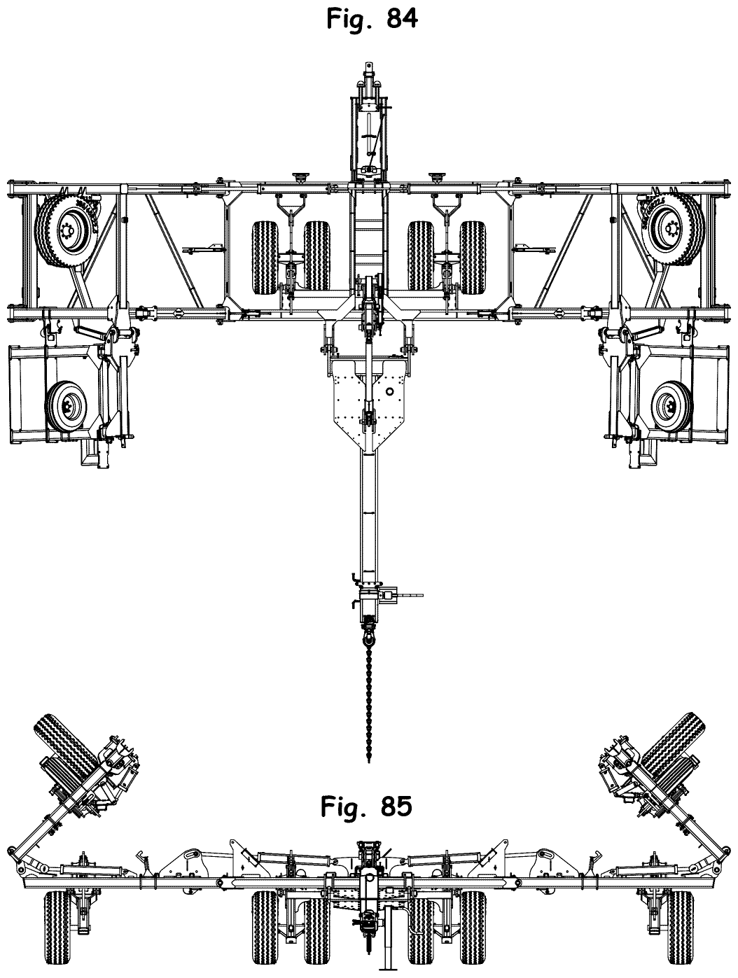

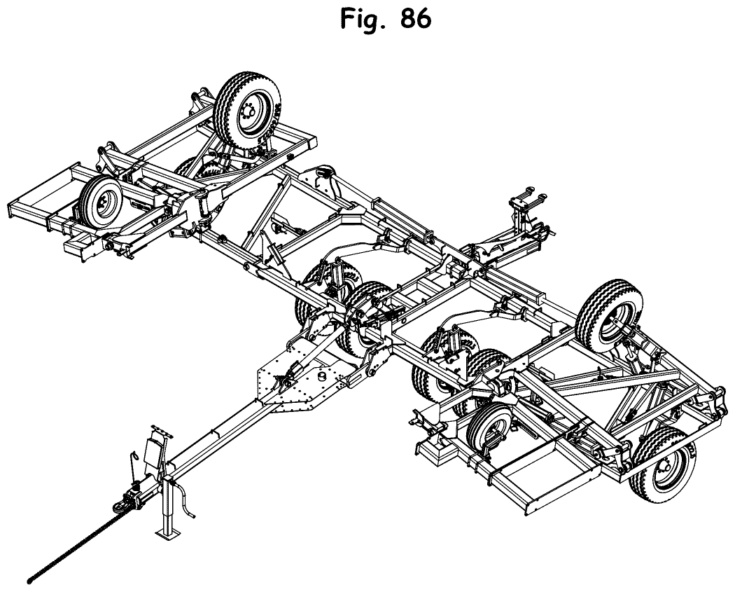

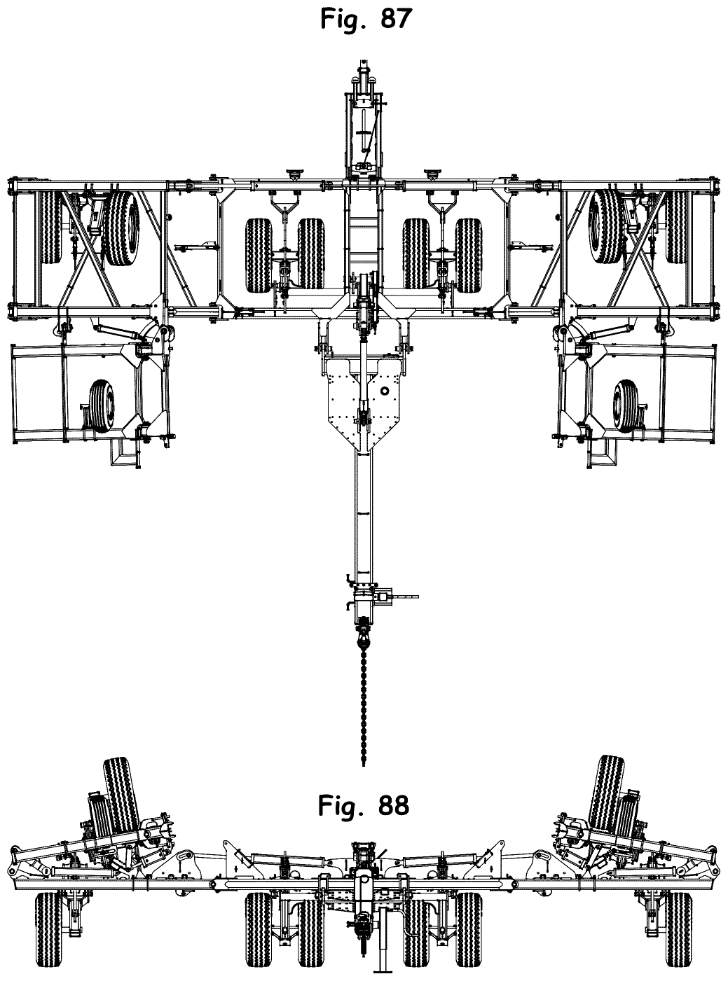

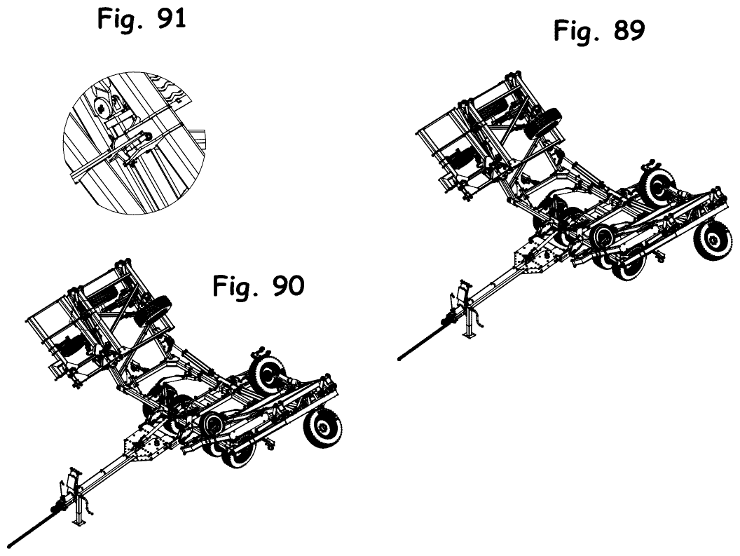

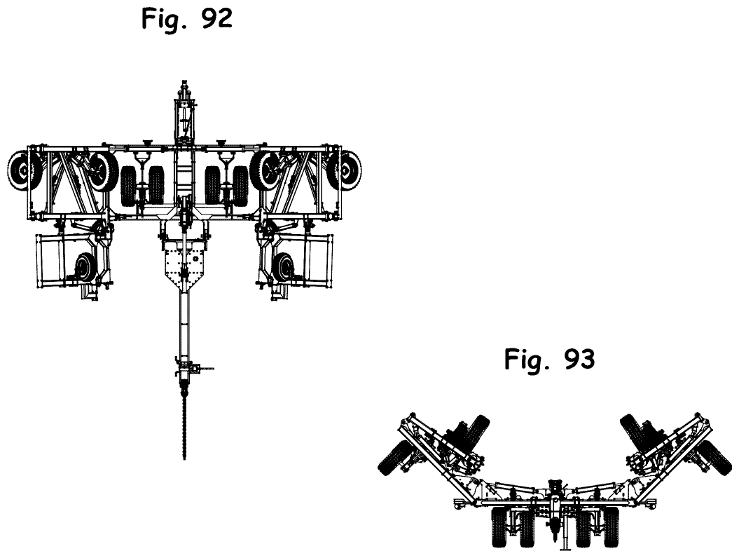

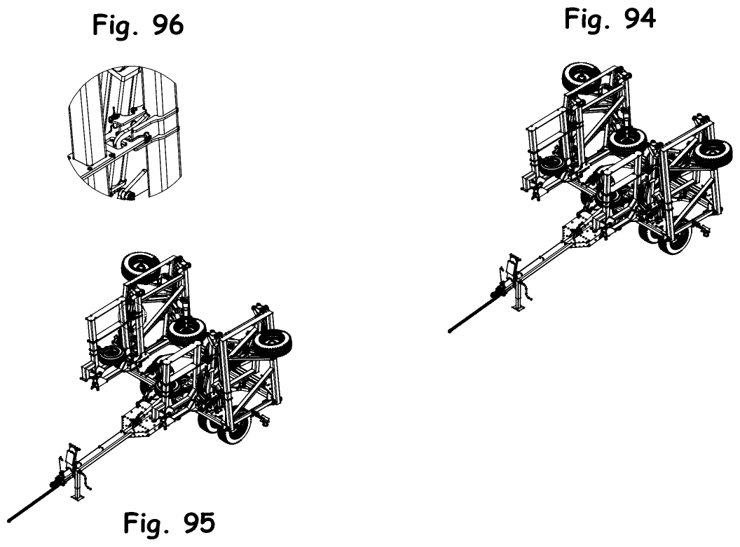

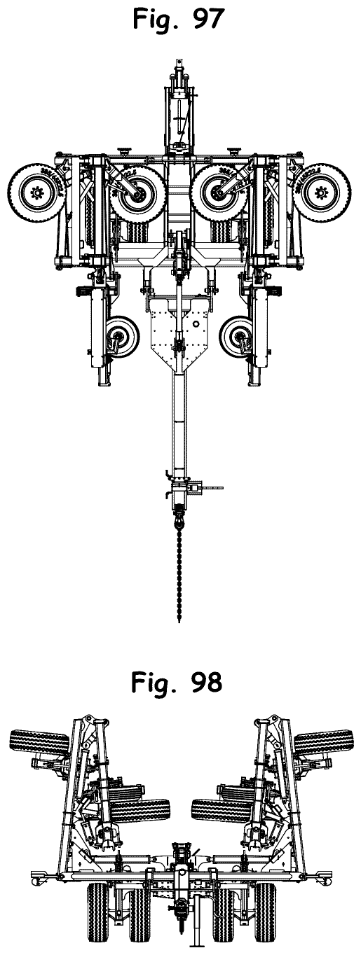

The third wing members 17 are pivotally coupled to the second wing members 16 for rotation about vertical axes 27. A third hydraulic actuator assembly 28 is interconnected between the second wing members 16 and the third wing members 17 of the wing frame assemblies 13, 14 for folding and unfolding the third wing members 17 relative to the second wing members 16 about the vertical axes 27. The third wing members 17 are configured to pivot forward 180 degrees about the vertical axes 27 from an extended working position, as illustrated in FIGS. 1 to 24 and 40 to 60, to a folded transport position, as illustrated in FIGS. 32 to 39 and 66 to 70.

The third wing members 17 comprise flex coupling systems 29 that allow the third wing members 17 to float about third horizontal axes 30 relative to the second wing members 16 when the third wing members 17 are in their extended working positions. The flex coupling systems 29 include main frames 31 pivotally connected to the second wing members 16 for rotation about the vertical axes 27, wing frames 32 pivotally connected to the main frames 31 for rotation about the third horizontal axes 30, and fourth hydraulic actuator assemblies 33 coupled between the main frames 31 and the wing frames 32.

The main frames 31 of the flex coupling systems 29 have guide supports 33 that face inwardly and engage outer frame members 34 of the second wing members 16 when the third wing members 17 are in their extended working positions. The wing frames 32 of the flex coupling systems 29 have guide supports 35 that face rearwardly and engage corresponding structures 26 on front frame members 36 of the second wing members 16 when the third wing members 17 are in their folded transport positions relative to the second wing members 16.

The fourth hydraulic actuator assemblies 33 limit a downward rotation of the wing frames 32 about the third horizontal axes 30 when the implement 10 is raised and/or when the third wing members 17 are being moved to their folded transport positions. The fourth hydraulic actuator assemblies 33 are coupled to the wing frames 32 by slots 37 that allow a limited range of floating movement between the main frames 31 and the wing frames 32. The slots 37 extend generally perpendicularly to the third horizontal axes 30 and have inner ends 37A that limit downward rotation of the wing frames 32 and outer ends 37B that limit upward rotation of the wing frames 32. A distance between the inner ends 37A and outer ends 37B of the slots 37 provides a range of floating movement between the main frames 31 and the wing frames 32. The fourth hydraulic actuator assemblies 33 are coupled to the slots 37 by lug pins 38 that slide or roll along the slots 37. The lug pins 38 in the illustrated embodiment are hardened rollers on pins that allow the second end of a turnbuckle 39 to move freely in the slot 37 to allow the implement 10 to flex when following uneven terrain.

The lug pins 38 are moved closer to the inner ends 37A of the slots 37 when the fourth actuator assemblies 33 are retracted. The slots 37 allow a limited range of upward and downward pivoting movement of the wing frame 32 relative to the main frame 31 when the fourth actuator assembly 33 is extended.

The fourth hydraulic actuator assemblies 33 each have a linear actuator 40, a fold strut 41, and the turnbuckle 39. The linear actuator 40 has a first end 40A pivotally connected to the main frame 31 and a second end 40B pivotally connected to a first end 41A of the fold strut 41 and a first end 39A of the turnbuckle 39. The turnbuckle 39 has a second end 39B supporting one of the lug pins 38 for sliding movement in a corresponding one of the slots 37. The fold strut 41 has a second end 41B pivotally connected to the wing frame 32 between the inner end 37A of the slot 37 and the main frame 31.

The turnbuckle 39 is adjustable in length to level the wing frame 32 when the linear actuator 40 is fully retracted. A turnbuckle lock 42 is provided to prevent the turnbuckle 39 from rotating once the wing frame 32 is adjusted to a level position.

A plurality of hydraulic lift cylinders 43, 44 are provided to move the ground support wheels 18, 20 on the carrier frame 12 and the first and second wing members 15, 16 to allow the implement 10 to be moved between a lowered field working position and a raised position for turning at the ends of the field or for transport.

The hydraulic lift cylinders 44 of the second wing members 16 are connected to the linear actuators 40 of the fourth hydraulic actuator assemblies 33 in a master slave relationship. When the implement 10 is raised to its raised transport position by the hydraulic lift cylinders 43, 44, the linear actuators 40 of the fourth hydraulic actuator assemblies 33 are retracted to move the lug pins 38 toward the inner ends 37A of the slots 37. The engagement between the lug pins 38 and the inner ends 37A of the slots 37 maintains the wing frames 32 level with the second wing members 16.

The master slave relationship between the hydraulic lift cylinders 44 and the linear actuators 40 causes the linear actuators 40 to be extended when the implement 10 is lowered to its field working position. When the linear actuator 40 is extended, the lug pins 38 will move to an approximate mid point along the slots 37 with the wing frames 32 level with the second wing members 16. This position allows the wing frames 32 to flex about the third horizontal axes 30 both upwardly and downwardly to follow uneven terrain.

The linear actuators 40 are arranged to rephase upon retraction so that when the implement 10 is lifted to its raised position by fully extending the hydraulic lift cylinders 43, 44, the linear actuators 40 will be fully retracted to cause the lift cylinders 43, 44 and the linear actuators 40 to stay in unison with each other after each cycle of raising the implement 10.

The third wing members 17 have preset gauge wheels 45 to control a depth of operation of the third wing members 17 when the implement 10 is lowered to its field working position. The gauge wheels 45 can be manually adjusted to set a desired depth of operation using pins 46 and a series of mounting holes 47 to change positions of the gauge wheels 45 relative to the wing frames 32. When the implement 10 is raised by the hydraulic lift cylinders 43, 44, and the linear actuators 40 are retracted to keep the third

wing members 17 level, the gauge wheels 45 will be raised above the surface of the ground and will not interfere with the folding operation of the third wing members 17 relative to the second wing members 16.

Gravity locks 48 are provided for holding the third wing members 17 in their folded transport positions relative to the second wing members 16. Safety pins 49 can also be placed through holes 50 in the guide supports 35 and corresponding holes or slots 51 on the second wing members 16 for additional security in holding the third wing members 17 in their folded transport positions.

Transport locks are provided that automatically engage to lock the first, second and third wing members 15, 16, 17 into their folded transport positions.

The multi section folding implement 10 according to the present invention includes the following features.

The main frame 31 acts as the main structure of the third wing members 17. The main frame 31 allows the entire wing member 17 to rotate 180 degrees for transport, and also allows the wing frame 32 to pivot up and down.

The wing frame 32 has the ability to pivot off of the main frame 31 allowing for increased flexibility on the outer wings 17. The wing frame 32 features a lug 38 and a slot 37 that allows the flexibility of the wing frame 32 of the third wing member 17 relative to the second wing member 16 to be controlled by the hydraulic actuator 40.

The fold strut 41 allows a constant distance from the wing frame 32 to the rod end pivot point 40B of the hydraulic actuator 40. The fold strut 41 helps the hydraulic actuator 40 in the flex process by taking a portion of the forces.

The turnbuckle 39 allows the wing frame 32 to be adjusted so that it is level with the main frame 31 (and the second wing member 16). The turnbuckle 39 also acts as a strut, and much like the fold strut 41 will take a portion of the forces and allow the wing frame 32 to flex up and down.

The turnbuckle lock 42 pivots over the turnbuckle 39 to prevent the turnbuckle 39 from rotating once the proper length of the turnbuckle 39 is set.

The hardened roller of the lug pin 38 is used in the flex slot 37 of the wing frame 32 to move freely along the slot 37 when the wing frame 32 is flexing in the field.

The linear actuator 40 functions as a “flex cylinder” operating in the lift circuit of the implement 10. The linear actuator 40 is connected to the last lift cylinder 44 on the second wing member 16 in a master slave system. The rod end 40B of the linear actuator 40 is connected to the rod end of the last lift cylinder 44. When the implement 10 is lifted in non-operating height, the linear actuator 40 is retracted causing the wing frame 32 to sit level with the main frame 31. When the implement 10 is lowered to operating height, the linear actuator 40 extends and allows the wing frame 32 to flex up and down due to the slot 37 on the wing frame 32. The linear actuator 40 is built with re-phasing on the retract so that when the implement 10 is lifted at the end of each pass each cylinder 44, 40 can reset and be in time with each other once again.

The structure of the multi section implement 10 of the present invention is described above. The operation of the implement 10 will now be described.

All of the wings (i.e., the first and second wing members 15, 16), except for the outer flex wing (i.e., the third wing member 17), are unfolded with the main fold hydraulic circuit.

The outer flex wing 17 is then swung 180 degrees so that it is oriented parallel with the rest of the wings 15, 16 and generally flat across the implement 10. If the wing frame 32 does not sit flat with the rest of the implement 10, then the turnbuckle 39 can be adjusted to level out the wing frame 32.

The implement 10 is positioned in the desired unfolded orientation and when ready to run the implement 10, the lift circuit is lowered to the desired height set by the single point depth control.

Lowering the lift circuit results in the extension of the flex cylinder 40. This allows the wing frame 32 to flex to follow the contour of the ground using the preset gauge wheel 45 as its guide.

When finished running the implement 10, it is lifted to its maximum height resulting in the retraction of the flex cylinder 40 and resulting in the wing frame 32 returning to its flat or level position. The full extension of the lift cylinders 43, 44, as well as the full retraction of the flex cylinder 40 allows the lift cylinders 43, 44 and flex cylinder 40 to stay in unison after each cycle of lifting the implement 10.

With the wing frame 32 in its flat/level position, the main frame 31 can be folded 180 degrees around into the transport position where it catches on the wing frame 32 and locks into place using the gravity lock 48.

The main fold circuit on the implement 10 is then activated which folds the main wing members 15, 16 into transport position. The wing members 15, 16 are locked into place using transport locks.

The present invention can also be applied to implements other than those specifically illustrated in the accompanying drawings. For example, the flex coupling system of the present invention could be incorporated into parts of the implement (e.g., the main frame sections or inner wings) other than the outer wing to provide additional frame flexibility independent of the pivot couplings responsible for folding and unfolding the machine.

While the invention has been described in connection with specific embodiments thereof, it is to be understood that this is by way of illustration and not of limitation, and the scope of the appended claims should be construed as broadly as the prior art will permit.

What is claimed is:

1. A farm implement comprising:
a frame assembly including a carrier frame and a pair of wing frame assemblies mounted to the carrier frame, each wing frame assembly including first, second, and third wing members with the first wing members pivotally coupled to the carrier frame for about first horizontal axes, the second wing members pivotally coupled to the first wing members for rotation about second horizontal axes, and the third wing members pivotally coupled to the second wing members for rotation about vertical axes;
first and second hydraulic actuator assemblies, wherein the first hydraulic actuator assembly is interconnected between the carrier frame and the first wing members of the wing frame assemblies for folding and unfolding the first wing members relative to the carrier frame about said first horizontal axes, and wherein the second hydraulic actuator assembly is interconnected between the first wing members and the second wing members of the wing frame assemblies for folding and unfolding the second wing members relative to the first wing members about said second horizontal axes;
a third hydraulic actuator assembly interconnected between the second wing members and the third wing members of the wing frame assemblies for folding and unfolding the third wing members relative to the second wing members about said vertical axes, said third wing members being configured to pivot forward about said vertical axes from an extended working position to a folded transport position; and
said third wing members comprise flex coupling systems that allow said third wing members to float about third horizontal axes relative to said second wing members when said third wing members are in their extended working positions.

2. The farm implement according to claim 1, wherein said flex coupling systems comprise main frames pivotally connected to said second wing members for rotation about said vertical axes, wing frames pivotally connected to said main frames for rotation about said third horizontal axes, and fourth hydraulic actuator assemblies coupled between said main frames and said wing frames for limiting a downward rotation of the wing frames about the third horizontal axes when the implement is raised and/or when the third wing members are being moved to their folded transport positions.

3. The farm implement according to claim 2, wherein said main frames of the flex coupling systems have guide supports that face inwardly and engage outer frame members of the second wing members when the third wing members are in their extended working positions, and wherein said wing frames of the flex coupling systems have guide supports that face rearwardly and engage front frame members of the second wing members when the third wing members are in their folded transport positions relative to the second wing members.

4. The farm implement according to claim 2, wherein said fourth hydraulic actuator assemblies are coupled to said wing frames by slots that allow a limited range of floating movement between said main frames and said wing frames.

5. The farm implement according to claim 4, wherein said slots extend generally perpendicularly to said third horizontal axes and have inner ends that limit downward rotation of the wing frames, outer ends that limit upward rotation of the wing frames, and a distance between said inner and outer ends that provides a range of floating movement between the main frames and the wing frames.

6. The farm implement according to claim 5, wherein said fourth hydraulic actuator assemblies are coupled to the slots by lug pins that slide along the slots, and wherein said lug pins are moved closer to the inner ends of the slots when the fourth hydraulic actuator assemblies are retracted.

7. The farm implement according to claim 6, wherein said fourth hydraulic actuator assemblies each comprises a linear actuator, a fold strut, and a turnbuckle, said linear actuator having a first end pivotally connected to the main frame and a second end pivotally connected to a first end of said fold strut and a first end of said turnbuckle, said turnbuckle having a second end supporting one of said lug pins for sliding movement in a corresponding one of said slots, and said fold strut having a second end pivotally connected to said wing frame between the inner end of said slot and said main frame.

8. The farm implement according to claim 7, wherein said turnbuckle is adjustable in length to level the wing frame when said linear actuator is fully retracted.

9. The farm implement according to claim 8, further comprising a turnbuckle lock that prevents the turnbuckle from rotating once the wing frame is adjusted to a level position.

10. The farm implement according to claim 8, wherein said slot allows a limited range of upward and downward pivoting movement of the wing frame relative to the main frame when the linear actuator is extended.

11. The farm implement according to claim 10, wherein said lug pins comprise hardened rollers on pins that allow the second end of the turnbuckle to move freely in the slot to allow the implement to flex when following uneven terrain.

12. The farm implement according to claim 7, wherein ground support wheels are provided on the carrier frame, the first wing members, and the second wing members, and a plurality of hydraulic lift cylinders are provided to move the carrier frame and the first and second wing members between a lowered field working position and a raised transport position.

13. The farm implement according to claim 12, wherein at least one of the hydraulic lift cylinders are connected to said linear actuators of the flex coupling systems in a master slave relationship so that when the implement is moved to its raised transport position the linear actuators are retracted to maintain the wing frames level with the second wing members.

14. The farm implement according to claim 13, wherein said master slave relationship between said at least one of the hydraulic lift cylinders and the linear actuators causes the linear actuators to be extended when the implement is lowered to its field working position to allow the wing frames to flex about the fourth horizontal axes to follow uneven terrain.

15. The farm implement according to claim 14, wherein said linear actuators are arranged to re-phase upon retraction so that when the implement is lifted to its raised position by fully extending the hydraulic lift cylinders, the linear actuators will be fully retracted to cause the lift cylinders and the linear actuators to stay in unison with each other after each cycle of raising the implement.

16. The farm implement according to claim 1, wherein said third wing members are configured to pivot 180 degrees about said vertical axes between said extended working positions and said folded transport positions.

17. The farm implement according to claim 1, wherein said first wing members and said second wing members are configured to be folded and unfolded with a single fold circuit.

18. The farm implement according to claim 1, wherein said third wing members have preset gauge wheels to control a depth of operation of the third wing members when the implement is lowered to its field working position.

19. The farm implement according to claim 1, further comprising a gravity lock for holding the third wing members in their folded transport positions relative to the second wing members.

20. The farm implement according to claim 1, further comprising transport locks that automatically engage to lock the first, second and third wing members into their folded transport positions.

21. A farm implement comprising:
a frame assembly including a carrier frame and a pair of wing frame assemblies mounted to the carrier frame, each wing frame assembly including first, second and third wing members, wherein the first wing members are pivotally coupled to the carrier frame for rotation about first horizontal axes, the second wing members are pivotally coupled to the first wing members for rotation about second horizontal axes, and the third wing members are pivotally coupled to the second wing members for rotation about vertical axes;
hydraulic actuator assemblies configured to fold and unfold the wing members about the respective horizontal and vertical axes;
flex coupling systems on the third wing members comprising main frames pivotally connected to the second wing members for rotation about the vertical axes, wing frames pivotally connected to the main frames for rotation about longitudinal horizontal axes, and a connection system allowing limited floating movement of the wing frames relative to the main frames, said connection system including slotted guide supports with slots, and lug pins that slide within the slots;
ground support wheels on the carrier frame, the first wing members, and the second wing members, and a hydraulic system for moving the ground support wheels relative to the carrier frame and first and second wing members for moving the carrier frame and the first and second wing members between a lowered field working position and a raised transport position;
adjustable gauge wheels on the third wing members for controlling a depth of operation of the third wing members in their extended working positions; and
wherein the flex coupling systems enable the third wing members to float about the longitudinal horizontal axes in response to uneven terrain while maintaining alignment with the second wing members.
